(19) United States
(12) Patent Application Publication
(10) Pub. No.: US 2016/0055377 A1
(43) Pub. Date: Feb. 25, 2016

(54) REAL-TIME ANALYTICS TO IDENTIFY VISUAL OBJECTS OF INTEREST

(71) Applicant: INTERNATIONAL BUSINESS MACHINES CORPORATION, ARMONK, NY (US)

(72) Inventors: Brian Martin Anderson, Dunwoody, GA (US); Randy Scott Johnson, O'Fallon, MO (US); Scott Bradley Katzman, Dallas, GA (US); John Falk Kelley, Clarkesville, GA (US); Jacob Charles Schneider, Lawrenceville, GA (US); Kaleb Dean Walton, Fenton, MI (US)

(21) Appl. No.: 14/462,922

(22) Filed: Aug. 19, 2014

(51) Int. Cl. G06K 9/00; G06F 3/01; G06T 11/60; G06T 5/00

(52) U.S. Cl. CPC G06K 9/00671; G06T 5/008; G06F 3/017; G06T 11/60

(57) ABSTRACT

A method of identifying and suggesting objects for a user within a user's field of vision of a personal imaging system. A user's field of vision within the system is monitored. The personal imaging system requests feedback regarding objects that are focused on within the user's field of vision. The feedback from the user is associated with the user's profile which includes at least demographics. A real-time correlation of the user's profile and demographics with other users is performed to provide a correlation interest score. The interest score may be used to recommend and direct the user's attention to other objects within the user's field of vision that the user may be interested in.

### BACKGROUND

The present invention relates to identification of visual objects within a field of vision, and more specifically to providing a suggestion regarding a focus field of vision seen through a personal imaging system based on passive interest input and real-time analytics.

Personal imaging systems are wearable computers which add information onto a reality or actually help people see better. Personal imaging systems may use an optical head-mounted display (OHMD) or computerized internet-connected glasses with transparent heads-up display (HUD) or augmented reality (AR) overlay that has the capability of reflecting projected digital images, which can be seen through by the user.

The personal imaging systems may collect information from internal or external sensors. Some of the sensors may track acceleration, temperature, altitude, barometric pressure, direction in a frame of reference that is stationary relative to the surface of the Earth, and other conditions.

Additionally, the personal imaging system may control, or retrieve data from, other instruments or computers, for example through wireless technologies. The personal imaging system may also contain a storage device.

Since the personal imaging system is worn, input to the personal imaging system may be accomplished through buttons, touchpad, compatible devices for remote control, speech recognition of commands issued by the user, gesture recognition, eye tracking and brain-computer interface.

### SUMMARY

According to one embodiment of the present invention a method of identifying and suggesting objects for a user within a user's field of vision of a personal imaging system. The method comprising the steps of: a computer monitoring the user's field of vision of the personal imaging system; the computer identifying at least one object within the user's field of vision of the personal imaging system; the computer determining that information regarding the object identified is present in the repository; the computer performing a real-time correlation of the user's profile and demographics with other users with a similar demographic to provide a correlation interest score; and if the correlation interest score exceeds a predefined threshold, the computer highlighting the object in the user's field of vision through the personal imaging system.

According to another embodiment of the present invention, a method of identifying and suggesting objects for a user within a user's field of vision of a personal imaging system. The system comprising the steps of: a computer monitoring the user's field of vision of the personal imaging system; if the computer identifies at least one object within the user's field of vision of the personal imaging system, the computer: determining that the user is focusing on an object; requesting feedback from a user regarding at least one object identified in the user's field of vision through the personal imaging system; and associating received feedback from the user with the user's profile comprising demographics and storing the feedback in a repository; if the computer determines that information regarding the object is present in the repository, the computer performing a real-time correlation of the user's profile and demographics with other users with a similar demographic to provide a correlation interest score; and if the correlation interest score exceeds a predefined threshold, the computer highlighting the object in the user's field of vision through the personal imaging system.

According to another embodiment of the present invention, a method of identifying and suggesting objects for a user within a user's field of vision of a personal imaging system. The method comprising the steps of: a computer monitoring the user's field of vision of the personal imaging system; if the computer identifies at least one object within the user's field of vision of the personal imaging system, the computer: determining that the user is focusing on an object; requesting feedback from a user regarding at least one identified object in the user's field of vision through the personal imaging system; and associating received feedback from the user with the user's profile comprising demographics and storing the feedback in a repository.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flow diagram of a method of registering a user within a demographic.

FIG. 3 shows a flow diagram of a method of identifying and suggesting objects for the user within the user's field of vision of a personal imaging system.

FIG. 4 shows a schematic of an example of the method of identifying and suggesting objects for the user within the user's field of vision of a personal imaging system.

FIG. 5 illustrates internal and external components of a client or device computer and a server computer in which illustrative embodiments may be implemented.

### DETAILED DESCRIPTION

In an illustrative embodiment, it is recognized that the methods, computer program product and computer system may be implemented through a personal imaging system of a user which collects information from internal or external sensors. The personal imaging system may control, or retrieve data from, other instruments or computers, for example through wireless technologies and may contain a storage device. Input to the personal imaging system may be accomplished through buttons, touchpad, compatible devices for remote control, speech recognition of commands issued by the user, gesture recognition, eye tracking and brain-computer interface.

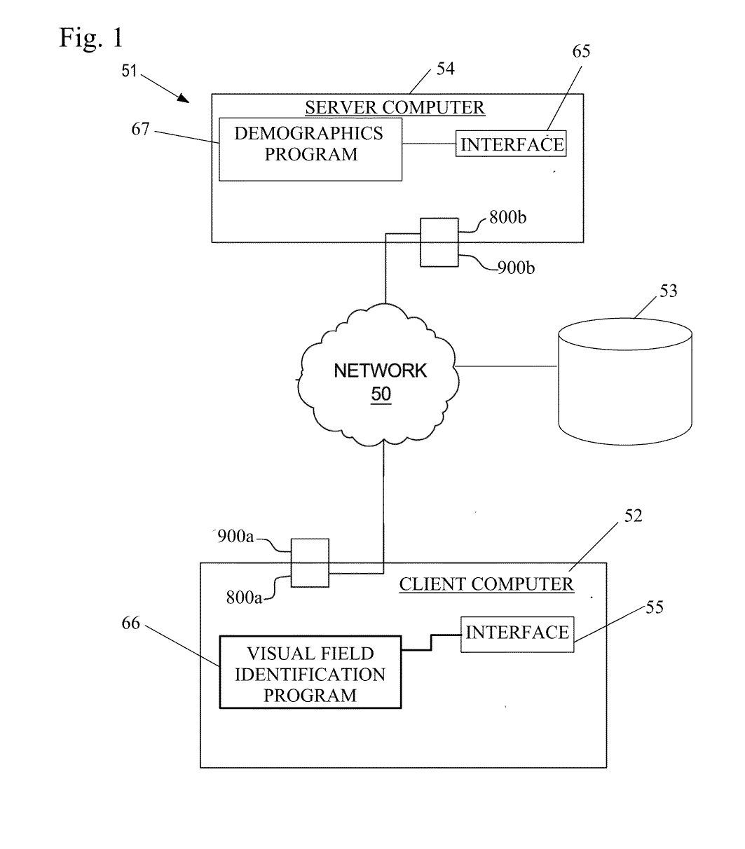

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, and a server computer 54 connect to network 50. In other exemplary embodiments, network data processing system 51 may include additional client or device computers, storage devices or repositories, server computers, and other devices not shown.

Device computer 52 may be, for example, a mobile device, a cell phone, a personal digital assistant, a netbook, a laptop computer, a tablet computer, a desktop computer, personal imaging device or any other type of computing device.

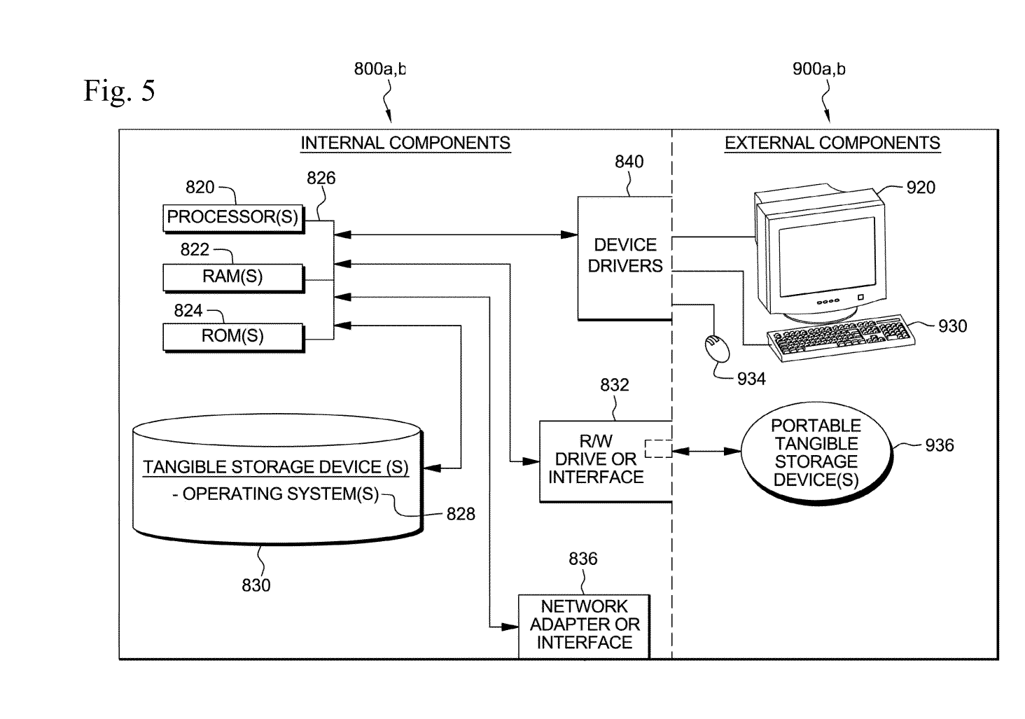

Device computer 52 may contain an interface 55. The interface 55 may accept commands and data entry from a user. The interface 55 can be, for example, a command line interface, a graphical user interface (GUI), or a web user interface (WUI) or alternatively on server computer 54. The device computer 52 preferably includes a visual field identification program 66. While not shown, it may be desirable to have the visual identification program 66 be present on the server computer 54. Device computer 52 includes a set of internal components 800a and a set of external components 900a, further illustrated in FIG. 5.

Server computer 54 includes a set of internal components 800b and a set of external components 900b illustrated in FIG. 5. The server computer 54 may contain an interface 65. The interface 65 may accept commands, data entry, and a threshold score. The interface 65 can be, for example, a command line interface, a graphical user interface (GUI), or a web user interface (WUI). The server computer 54 also preferably includes a demographics program 67.

In the depicted example, server computer 54 provides information, such as boot files, operating system images, and applications to device computer 52. Server computer 54 can compute the information locally or extract the information from other computers on network 50.

Program code and programs such as a demographics program 67 and a visual field identification program 66 may be stored on at least one of one or more computer-readable tangible storage devices 830 shown in FIG. 5, on at least one of one or more portable computer-readable tangible storage devices 936 as shown in FIG. 5, on repository 53 connected to network 50, or downloaded to a data processing system or other device for use. For example, program code and programs such as a demographics program 67 and a visual field identification program 66 may be stored on at least one of one or more tangible storage devices 830 on server computer 54 and downloaded to the device computer 52. Alternatively, server computer 54 can be a web server, and the program code and programs such as a demographics program 67 and a visual field identification program 66 may be stored on at least one of the one or more tangible storage devices 830 on server computer 54 and accessed on the device computer 52. Demographics program 67 and a visual field identification program 66 can be accessed on device computer 52 through interface 55. In other exemplary embodiments, the program code and programs such as a demographics program 67 and a visual field identification program 66 may be stored on at least one of one or more computer-readable tangible storage devices 830 on server computer 54 or distributed between two or more servers.

Embodiments of the present invention are capable of being implemented in a cloud computing environment and in conjunction with any other type of computing environment now known or later developed.

The server computer 54 and repository 53 may be practiced in distributed cloud computing environments where tasks are performed by remote processing devices that are linked through a communications network. In a distributed cloud computing environment, program modules may be located in both local and remote computer system storage media including memory storage devices. A computer system/server computer may also communicate with one or more external devices, such as device computer 52. The computer system/server computer typically includes a variety of computer system readable media. Such media may be any available media that is accessible by computer system/server computer, and it includes both volatile and non-volatile media, removable and non-removable media.

Cloud computing is a model of service delivery for enabling convenient, on-demand network access to a shared pool of configurable computing resources (e.g. networks, network bandwidth, servers, processing, memory, storage, applications, virtual machines, and services)that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

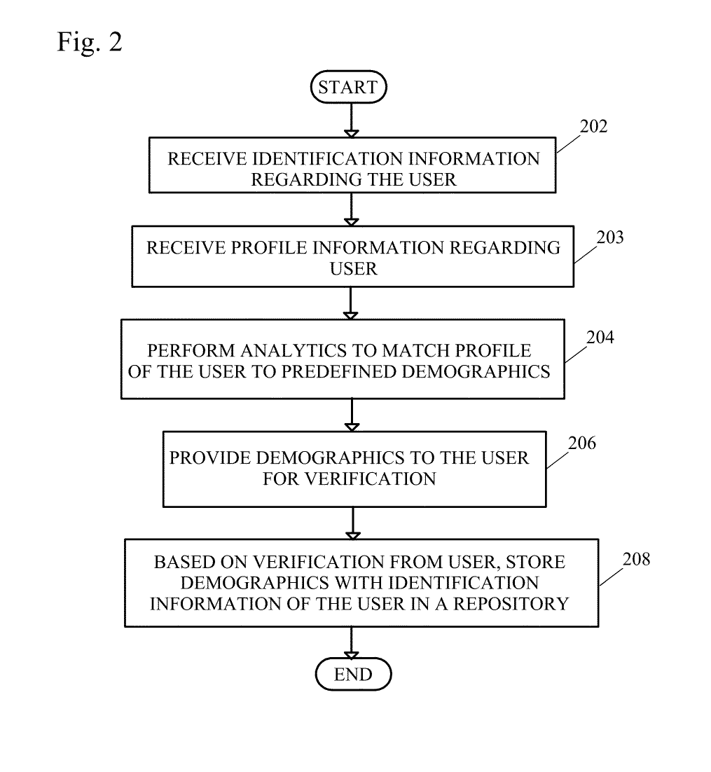

FIG. 2 shows a flow diagram of a method of registering a user within a demographic.

In a first step, identification information is received regarding a user that is to use a personal imaging system (step 202), for example by the demographics program 67. The user may enter the identification information through an interface of the personal imaging system itself, a web user interface (WUI) or alternatively on the server computer 54.

The identification information may include, but is not limited to, name, address, age, telephone number, e-mail address, and other similar information.

The system will also receive profile information from the user regarding the user's interests, preferences, likes or dislikes, or other information that can be used to find other users with similar tastes (step 203). This could be done by presenting the user with a questionnaire, a form asking for ranking of activities, or other methods.

Analytics are performed to match the profile information of the user to a database of predefined demographics (step 204), for example by the demographics program 67. The predefined demographics may include information on other users who might have similar tastes, potential objects or fields of interest, or other information.

The predefined demographics are provided to the user for verification (step 206). The user may be presented with potential matches of people, including some demographic information about them, or perhaps an indication of some information which may be used to suggest objects for him to look at. The user may then select which of the predefined demographics he believes best describes his preferences.

Once verification of at least one predefined demographic is received from the user, the verified demographics are stored with the identification of the user in a repository (step 208), for example repository 53, and the method ends.

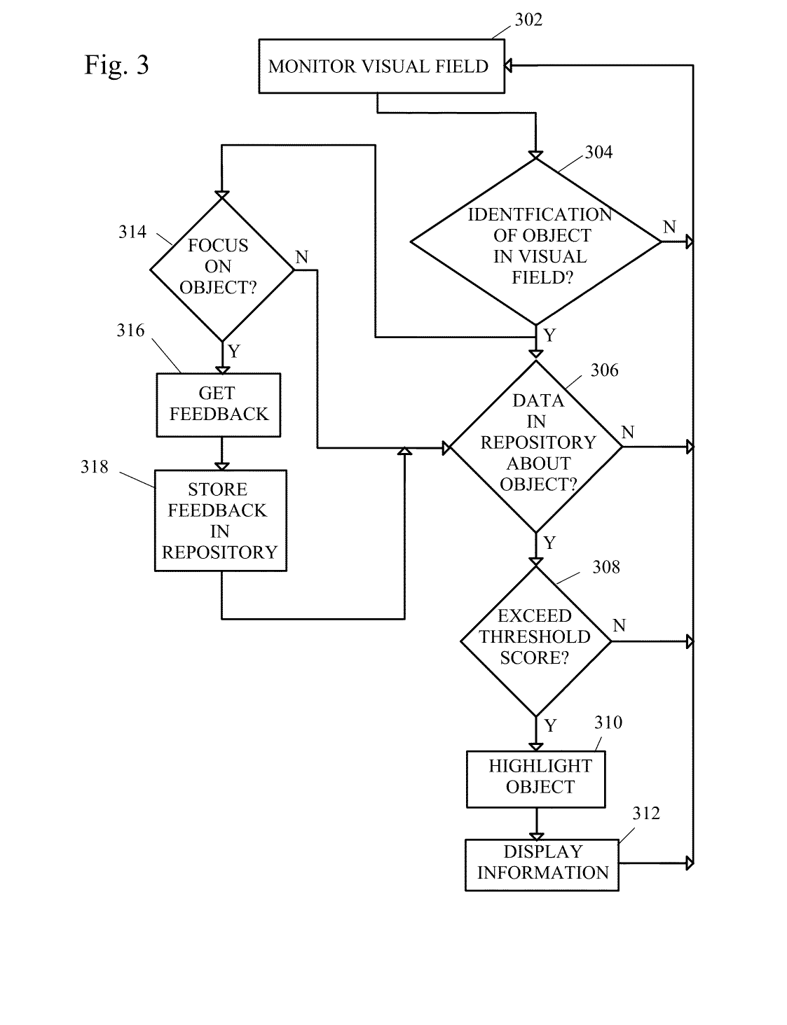

FIG. 3 shows a flow diagram of a method of identifying and suggesting objects for the user within the user's field of vision of a personal imaging system. It should be noted that the method of FIG. 3 preferably takes place after the method of FIG. 2.

In a first step, the visual field of the personal imaging system is monitored (step 302), for example by the visual field identification program 66.

If an object is identified in the visual field (step 304), and it is determined that the user of the personal imaging system is focusing on an object (step 314), the personal imaging system requests and obtains feedback regarding the object focused on by user (step 316), for example through the visual field identification program 66. The feedback may be an indication of whether the user likes or dislikes the identified object, an indication of whether a user would wish to purchase the object or visit the place, if the user agrees with a price of the object, if the user “knows” the object, if the object can endanger or is dangerous to the user, if the object could be recommended to another person on social media, tagging/bookmarking the object for later consideration by the user or other feedback.

If it is determined that the user of the personal imaging system is not focusing on an object (step 314), the method continues to step 306 of determining whether information is present within the repository in the object.

Alternatively, if the user has disabled providing feedback or feedback is already present from the user regarding the object in the field, steps 314, 316 and 318 may be bypassed and the method proceeds to step 306.

The personal imaging system receives feedback from the user regarding the identified object, and stores the feedback in a repository (step 318). The stored feedback may be associated with the user's profile and demographics, for example through the demographics program 67. The feedback may be received from the user through buttons, touchpad, compatible devices for remote control, speech recognition of commands, gesture recognition, eye tracking, brain-computer interface and/or any other means. The repository may be repository 53 or another repository associated with the personal imaging system.

After the feedback is stored in the repository, the system determines whether data is present in the repository about the object (step 306), for example through the visual identification program 66. The data regarding the object may include, but is not limited to, characteristics of the object. Characteristics may include a correlation interest score, hours a particular place is open, a price for the object or fee for admission to the place, reviews by other users, and/or historical information. The correlation interest score is a score of the object in which a user profile and associated demographics are correlated with other users with similar demographics in real-time. The correlation interest score is calculated using correlation analysis, for example by the demographics program 67. The correlation score may be impacted by the feedback provided by the user. The correlation interest score may also include fuzzy correlation analysis which determines the strength of a linear relationship between fuzzy attributes and the direction of the relationship.

If the correlation interest score exceeds a threshold score (step 308), the object is identified within the visual field of the personal imaging system (step 310) to the user, for example through the visual field identification program 66. The identification could comprise highlighting the object. Some ways of highlighting the object include, but are not limited to displaying an arrow pointing to the object, or putting a box, halo or other shape around the object, emphasizing the object with a color or any other way of identifying to the user that a particular object has been recognized and information about the object is available. The threshold score is preferably predefined.

Information regarding the object is then displayed on the visual field of the personal imaging system to the user (step 312), for example by the visual field identification program 66 and the method returns to step 302. The information may include, but is not limited to, characteristics of the at least one object. The information displayed or the identification of the object may distinguish whether the object being highlighted is a correlated interest based on demographics associated with the user's profile.

In another embodiment, the personal imaging system would not display the information to the user regarding the highlighted object, unless the user specifically requested the information regarding the highlighted object. The request may be received from the user through buttons, touchpad, compatible devices for remote control, speech recognition of commands, gesture recognition, eye tracking, brain-computer interface and/or any other means.

If an object is not identified in the visual field (step 304), the method returns to step 302.

If data regarding the object in the visual field of the personal imaging system is not present in the repository (step 306), the method returns to step 302.

If the correlation interest score of the object does not exceed a threshold score (step 308), the method returns to step 302.

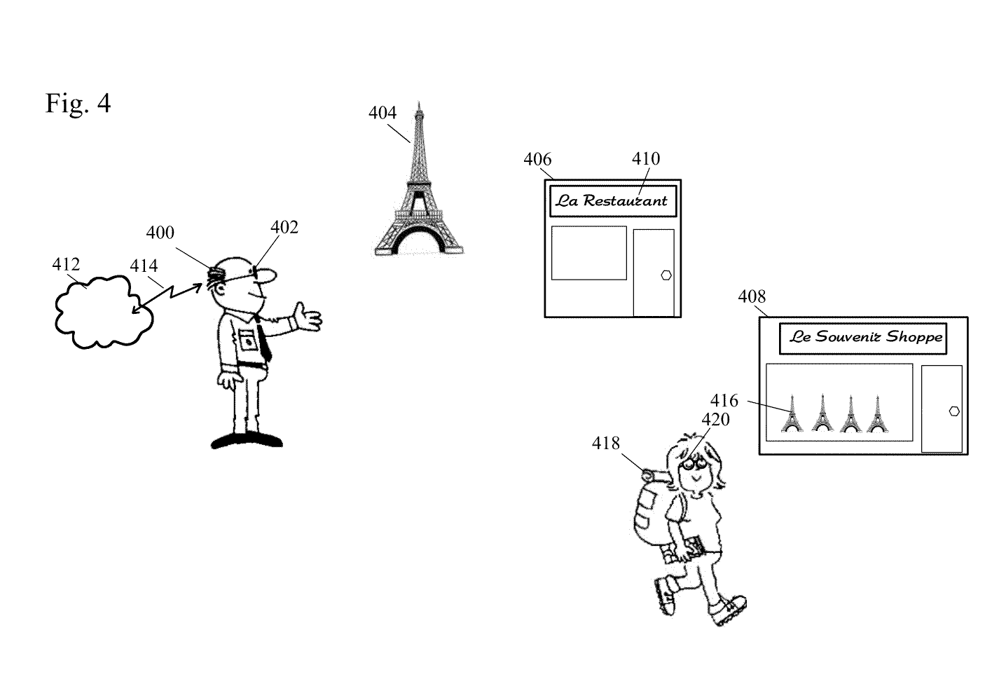

FIG. 4 shows a schematic of an example of the method of identifying and suggesting objects for the user within the user's field of vision of a personal imaging system.

Joe 400 purchases a personal imaging system 402 and sends his identification to the personal imaging system 402 or through a computer to the personal imaging system to establish a profile that includes Joe's basic information and his preferences. The personal imaging system 402 performs analytics to match at least some of Joe's information to at least one predefined demographic, for example art history buff and historian. The predefined demographic is provided to Joe for verification along with a list of objects that may be of interest to Joe, for example the Eiffel Tower and the Mona Lisa. Joe verifies that he is interested in the Eiffel Tower and is a historian.

Joe 400 is touring Paris and notices the Eiffel Tower 404. Joe 400 focuses on the Eiffel Tower 404 and a halo forms around it and flashes within the field of vision of the personal imaging system 402. Joe 400 submits his interest in the Eiffel Tower 404 through nodding his head. The personal imaging system 402 receives Joe's feedback regarding his interest in the Eiffel Tower 404 and the feedback is sent to a cloud service 412 through a connection 414. Due to Joe's interest and feedback, additional information regarding the Eiffel Tower 404 may be displayed to Joe through the personal imaging system.

Joe 400 notices signage 410 for a restaurant called “La Restaurant” 406 that Joe 400 has eaten at and did not like. He focuses on the signage 410 and when the halo forms around the signage 410, Joe 400 shakes his head to indicate that he does not like the restaurant 406. The personal imaging system 402 receives Joe's feedback regarding his disinterest in the restaurant 406 and the feedback is sent to a cloud service 412 through a connection 414.

Joe 400 continues to walk around Paris and heads into a store 408 and glances past an Eiffel Tower miniature 416, but does not notice it. The system recognizes the miniature Eiffel Tower as an object, and looks it up in the database. Since Joe has indicated that he is interested in the Eiffel Tower previously, the system assigns a high score to the Eiffel Tower miniature object. An indicator is displayed by the system to direct Joe's attention to the Eiffel Tower miniature 416 based on his interest in the real Eiffel Tower which he expressed earlier.

As Joe 400 continues to walk around Paris, another restaurant appears in the visual field. The personal imaging system looks up the restaurant in the database and finds some information on it which indicates that people having similar demographics to Joe's rated this new restaurant as being similar to “La Restaurant”. Based on Joe's disinterest or dislike of “La Restaurant”, the system assigns a low score to the new restaurant and does not point it out to Joe.

Sally 418 also travels to Paris as a tourist and has a personal imaging system 420. Sally is in the same age range as Joe and has verified an interest in some of the same objects as Joe. As she walks around Paris, an Eiffel Tower miniature 416 enters her field of vision. As with Joe, the system looks up the Eiffel Tower, discovers it in the database, and assigns a higher score to the Tower because others having similar demographics (i.e. Joe) were interested in it. The system puts an indicator within Sally's field of vision to direct her attention to the Eiffel Tower miniatures 416 in the “Le Souvenir Shoppe” 408.

The indicator in her field of vision preferably indicates that this indication is based on correlated interest, not her specific interest in the object. She likes the Eiffel Tower and decides to purchase the Eiffel Tower miniature 416.

FIG. 5 illustrates internal and external components of device computer 52 and server computer 54 in which illustrative embodiments may be implemented. In FIG. 5, device computer 52 and server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, demographics program 67 and visual field identification program 66 are stored on one or more of the computer-readable tangible storage devices 830 for execution by one or more of the processors 820 via one or more of the RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Demographics program 67 and visual field identification program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Demographics program 67 and visual field identification program 66 can be downloaded to the device computer 52 and server computer 54 from an external computer via a network (for example, the Internet, a local area network or other, wide area network) and network adapter or interface 836. From the network adapter or interface 836, demographics program 67 and visual field identification program 66 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Demographics program 67 and visual field identification program 66 can be written in various programming languages including low-level, high-level, object-oriented or non object-oriented languages. Alternatively, the functions of a demographics program 67 and a visual field identification program 66 can be implemented in whole or in part by computer circuits and other hardware (not shown).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having thus described the invention of the present application in detail and by reference to embodiments thereof, it will be apparent that modifications and variations are possible without departing from the scope of the invention defined in the appended claims.

What is claimed is:

1. A method of identifying and suggesting objects for a user within a user's field of vision of a personal imaging system comprising the steps of:
a computer monitoring the user's field of vision of the personal imaging system;
the computer identifying at least one object within the user's field of vision of the personal imaging system;
the computer determining that information regarding the object identified is present in a repository;
the computer performing a real-time correlation of the user's profile and associated user demographics with other user's demographics to provide a correlation interest score; and
if the correlation interest score exceeds a predefined threshold, the computer highlighting the object in the user's field of vision through the personal imaging system.

2. The method of claim 1, further comprising the step of displaying characteristics of the identified object to the user in the user's field of vision.

3. The method of claim 1, wherein if the computer identifies at least one object within the user's field of vision of the personal imaging system, the method further comprising the steps of the computer:
determining that the user is focusing on an object;
requesting feedback from a user regarding at least one object identified in the user's field of vision through the personal imaging system; and
associating received feedback from the user with the user's profile comprising demographics and storing the feedback in a repository.

4. The method of claim 1, prior to the steps of the computer monitoring the user's field of vision, the method further comprising the steps of:
the computer receiving identification information regarding the user of the personal imaging system;
the computer receiving profile information from the user regarding the user's interests;
the computer performing analytics to match the profile information of the user to predefined demographics;
the computer providing demographics to the user for verification; and
based on the verification received from the user, storing demographics with the profile and identification of the user in the repository.

5. The method of claim 3, wherein the feedback is through a user gesture.

6. The method of claim 1, wherein the highlighting of the object in the user's field of vision through the personal imaging system indicates whether the object is recommended based on demographics of the user and correlation interest score of the object.

7. A method of identifying and suggesting objects for a user within a user's field of vision of a personal imaging system comprising the steps of:
a computer monitoring the user's field of vision of the personal imaging system;
if the computer identifies at least one object within the user's field of vision of the personal imaging system, the computer:
determining that the user is focusing on an object;
requesting feedback from a user regarding at least one object identified in the user's field of vision through the personal imaging system; and
associating received feedback from the user with the user's profile and associated demographics and storing the feedback in a repository;
if the computer determines that information regarding the object is present in the repository, the computer performing a real-time correlation of the user's profile and associated demographics with other user's demographics to provide a correlation interest score; and
if the correlation interest score exceeds a predefined threshold, the computer highlighting the object in the user's field of vision through the personal imaging system.

8. The method of claim 7, prior to the steps of the computer monitoring the user's field of vision, the method further comprising the steps of:
the computer receiving identification information regarding the user of the personal imaging system;
the computer receiving profile information from the user regarding the user's interests;
the computer performing analytics to match the profile information of the user to predefined demographics;
the computer providing demographics to the user for verification; and
based on the verification received from the user, storing demographics with the profile and identification of the user in the repository.

9. The method of claim 7, wherein the feedback is through a user gesture.

10. The method of claim 7, wherein the highlighting of the object in the user's field of vision through the personal imaging system indicates whether the object is recommended based on demographics of the user and correlation interest score of the object.

11. The method of claim 7, further comprising the step of displaying characteristics of the object identified to the user in the user's field of vision.

12. A method of identifying and suggesting objects for a user within a user's field of vision of a personal imaging system comprising the steps of:
a computer monitoring the user's field of vision of the personal imaging system;
if the computer identifies at least one object within the user's field of vision of the personal imaging system, the computer:
determining that the user is focusing on an object;
requesting feedback from a user regarding at least one identified object in the user's field of vision through the personal imaging system; and
associating received feedback from the user with the user's profile comprising demographics and storing the feedback in a repository.

13. The method of claim 12, further comprising the steps of:
if the computer determines that information regarding the object is present in the repository, the computer performing a real-time correlation of the user's profile and associated demographics with other user's demographics to provide a correlation interest score; and
if the correlation interest score exceeds a predefined threshold, the computer highlighting the object in the user's field of vision through the personal imaging system.

14. The method of claim 13, further comprising the step of displaying characteristics of the identified object to the user in the user's field of vision.

15. The method of claim 13, wherein the highlighting if the object in the user's field of vision through the personal imaging system indicates whether the object is recommended based on demographics of the user and correlation interest score of the object.

16. The method of claim 12, prior to the steps of the computer monitoring the user's field of vision, the method further comprising the steps of:
the computer receiving identification information regarding the user of the personal imaging system;
the computer receiving profile information from the user regarding the user's interests;
the computer performing analytics to match the profile information of the user to predefined demographics;
the computer providing demographics to the user for verification; and
based on the verification received from the user, storing demographics with the profile and identification of the user in the repository.

17. The method of claim 12, wherein the feedback is through a user gesture.
